(19) United States
(12) Patent Application Publication
(10) Pub. No.: US 2025/0326653 A1
(43) Pub. Date: Oct. 23, 2025

(54) PYROGENICALLY PREPARED SURFACE MODIFIED MAGNESIUM OXIDE

(71) Applicant: Evonik Operations GmbH, Essen (DE)

(72) Inventors: Daniel Dehe, Bruchkoebel (DE); Daniel Esken, Erlensee (DE); Christian Hofmann, Schluechtern (DE); Franz Schmidt, Gross-Gerau (DE)

(73) Assignee: Evonik Operations GmbH, Essen (DE)

(21) Appl. No.: 18/870,108

(22) PCT Filed: May 24, 2023
(86) PCT No.: PCT/EP2023/063924

§ 371 Date: Nov. 27, 2024

(30) Foreign Application Priority Data
Jun. 3, 2022 (EP) 22177292.4

(51) Int. Cl. C01F 5/06

(52) U.S. Cl. CPC C01F 5/06; C01P 2002/72; C01P 2004/04; C01P 2006/11; C01P 2006/12

(57) ABSTRACT

A pyrogenically prepared surface modified magnesium oxide finds application in electronics, catalysis, paints and oils and as cathode and/or anode active material coating for the production of cathodes and/or anodes in lithium-ion and sodium-ion batteries. In a process for the preparation of a pyrogenically prepared surface modified magnesium oxide, a surface modification and a thermal treatment at elevated temperatures adapts the physical and chemical properties of the magnesium oxide.

The present invention relates to a pyrogenically prepared surface modified magnesium oxide and a process for the preparation thereof as well as the use thereof.

Ceramic oxide particles, particularly silica, alumina, titania, and zirconia are known. For a variety of applications, the use of high-surface pyrogenic magnesium oxide is advantageous, e.g. for applications in the field of catalysis (e.g. in: S. Demirci et al., Materials Science in Semiconductor Processing 34 (2015), 154-161).

For some applications, it is necessary to treat the surface of the hydrophilic magnesium oxide in order to create a hydrophobic surface instead of a hydrophilic surface. On the one hand, the hydrophobic surface functionalization protects the magnesium oxide from the reaction with air moisture, on the other hand, a hydrophobic surface is important for compatibility in organic systems.

So far, the surface treatment of high-surface pyrogenic magnesium oxide has only been described with methyl silica sol. (e.g. in: N. R. Dhineshbabu et al., “Hydrophobicity, flame retardancy and antibacterial properties of cotton fabrics functionalized with MgO/methyl silicate nanocomposites”, RSC Adv. 2014, 4, 32161).

The variability of such surface treatment is very limited. It is therefore the objective of the present invention to provide a surface modified magnesium oxide with a broad spectrum of surface modification without altering the intended properties of the used magnesium oxide. Surprisingly, such combination of challenging tasks can be achieved by the present invention.

Thus, in a first aspect of the present invention a pyrogenically prepared, surface modified magnesium oxide is provided, which is characterized by:

| | |
|---|---|
| Surface area [m²/g] (DIN 66 131) | 50 to 350 |
| Tamped density [g/L] (DIN ISO 787/XI) | 20 to 120, preferably 40-120, |
| Drying loss [%] (DIN ISO 787 II) | less than 5 |
| Loss on ignition [%] (DIN 55 921) | 0.1 to 20 |
| Carbon content [%] (elemental analysis using a LECO C744 instrument) | 0.1 to 15. |

Thus, a second object of the present invention is a process for the preparation of the pyrogenically prepared, surface modified magnesium oxide, which is characterized in that a pyrogenically prepared hydrophilic magnesium oxide is sprayed with a surface modifying agent at room temperature and the mixture is subsequently treated thermally at a temperature of 50 to 300° C., preferably 80-180° C., over a period of 0.5 to 3 h.

An alternative method for surface modification of the pyrogenically prepared magnesium oxide can be carried out by treating the pyrogenic hydrophilic magnesium oxide with a surface modifying agent in vapor form and subsequently treating the mixture thermally at a temperature of 50 to 800° C., preferably 300-600° C., over a period of 0.5 to 6 h, preferably 0.5-2 h.

The thermal treatment can be conducted under protective gas, such as, for example, nitrogen. The surface treatment can be carried out in heatable mixers and dryers with spraying devices, either continuously or batchwise. Suitable devices can be, for example, plowshare mixers or plate, cyclone, or fluidized bed dryers.

The present invention has the advantage that commercially available silanes can be used to modify magnesium oxide and thus individually adapt the properties of magnesium oxide, depending on the desired properties and intended purposes.

Preferably a pyrogenically prepared, hydrophilic magnesium oxide is used, which is characterized by:

| | |
|---|---|
| Surface area [m²/g] (DIN 66 131) | 50 to 350 |
| Tamped density [g/L] (DIN ISO 787/XI) | 20 to 100 |
| Drying loss [%] (DIN ISO 787 II) | less than 5 |
| Loss on ignition [%] (DIN 55 921) | 0.1 to 15 |

As used herein, the term “pyrogenically produced hydrophilic magnesium oxide” relates to magnesium oxides which are directly produced by pyrogenic methods, also known as “fumed” methods, or by further modification of pyrogenically produced precursors. The term “pyrogenically produced”, “pyrogenic” and “fumed” are used equivalently in the context of the present invention. The fumed magnesium oxides may be prepared by means of flame hydrolysis or flame oxidation. This involves oxidizing or hydrolyzing of hydrolysable or oxidizable starting materials, generally in a hydrogen/oxygen flame. Starting materials typically used for pyrogenic methods include organic or inorganic substances, such as metal chlorides.

Thus, the hydrophilic magnesium oxide according can be prepared by means of flame spray pyrolysis, wherein

at least one solution of metal precursors, comprising
a magnesium salt
a solvent e.g. ethanol, methanol or water
   is subjected to flame spay pyrolysis.

During the flame spray pyrolysis process, the solution of metal compounds (metal precursors) in the form of fine droplets is typically introduced into a flame, which is formed by ignition of a fuel gas and an oxygen-containing gas, where the used metal precursors are oxidized and/or hydrolyzed to give the corresponding magnesium oxide.

This reaction initially forms highly disperse approximately spherical primary particles, which in the further course of the reaction coalesce to form aggregates. The aggregates can then accumulate into agglomerates. In contrast to the agglomerates, which as a rule can be separated into the aggregates relatively easily by introduction of energy, the aggregates are broken down further, if at all, only by intensive introduction of energy.

The produced aggregated compound can be referred to as “fumed” or “pyrogenically produced” magnesium oxide.

The flame spray pyrolysis process is in general described in WO 2015173114 A1 and elsewhere.

The flame spray pyrolysis process preferably comprises the following steps:
a) the solution of metal precursors is atomized to afford an aerosol by means of an atomizer gas,
b) the aerosol is brought to reaction in the reaction space of the reactor with a flame obtained by ignition of a mixture of fuel gas and an oxygen-containing gas to obtain a reaction stream,
c) the reaction stream is cooled and
d) the solid magnesium oxide is subsequently removed from the reaction stream.

Metal precursors employed in the process include magnesium salts such as magnesium chloride, magnesium nitrate or magnesium acetate.

The solvent of this solution can be all typical solvents such as water, ethanol, methanol and others.

The amount of metal precursors in the solution may range of from 5 to 80 wt.-%, preferably of from 20 to 70 wt.-%, based on the total weight of the solution.

Examples of fuel gases are hydrogen, methane, ethane, natural gas and/or carbon monoxide. It is particularly preferable to employ hydrogen.

The oxygen-containing gas is generally air or oxygen-enriched air. An oxygen-containing gas is employed in particular for embodiments where for example a high BET surface area of the magnesium oxide to be produced is desired. The total amount of oxygen is generally chosen such that, it is sufficient at least for complete conversion of the fuel gas and the metal precursors.

For obtaining the aerosol, the vaporized solution containing metal precursors can be mixed with an atomizer gas, such as nitrogen, air, and/or other gases. The resulting fine droplets of the aerosol preferably have an average droplet size of 1-120 μm, particularly preferably of 30-100 μm. The droplets are typically produced using single- or multi-material nozzles. To increase the solubility of the metal precursors and to attain a suitable viscosity for atomization of the solution, the solution may be heated.

The particle size of the magnesium oxides can be varied by means of the reaction conditions, such as, for example, flame temperature, hydrogen or oxygen proportion, magnesium salt quantity, residence time in the flame, or length of the coagulation zone.

The process described above provides a high surface area, pyrogenically prepared, hydrophilic magnesium oxide that has a specific BET surface area of 50-350 m²/g, preferably 150-300 m²/g.

This material itself is advantageous with respect to the balanced properties which allows a broad spectrum of applications for this material. Besides that, this material provides an advantageous basis for the provision of inventive surface-modified magnesium oxides.

As surface modifying agent, it is possible to employ the following compounds and mixtures of the following compounds:
a) Organosilanes of the type (RO)₃Si(CₙH₂ₙ₊₁) and (RO)₃Si(CₙH₂ₙ₋₁), wherein
   R=alkyl, such as, for example, methyl, ethyl, n propyl, i-propyl, butyl, and
   n=1-20
b) Organosilanes of the type R′ₓ(RO)_{y}Si(CₙH₂ₙ₊₁) and R′ₓ(RO)_{y}Si(CₙH₂ₙ₋₁) wherein
R=alkyl, such as, for example, methyl-, ethyl-, n-propyl-, i-propyl-, butyl-
R′=alkyl, such as, for example, methyl, ethyl, n-propyl, i-propyl, butyl
R′=cycloalkyl
n=1-20
x+y=3
x=1, 2, and
y=1, 2
c) Halogen organosilanes of the type X₃Si(CₙH₂ₙ₊₁) and X₃Si(CₙH₂ₙ₋₁), wherein
X=Cl, Br
n=1-20
d) Halogen organosilanes of the type X₂(R′)Si(CₙH₂ₙ₊₁) and X₂(R′)Si(CₙH₂ₙ₋₁), wherein
X=Cl, Br
R′=alkyl, such as, for example, methyl, ethyl, n-propyl, i-propyl, butyl
R′=cycloalkyl
n=1-20
e) Halogen organosilanes of the type X(R′)₂Si(CₙH₂ₙ₊₁) and X(R′)₂Si(CₙH₂ₙ₋₁), wherein
X=Cl, Br
R′=alkyl, such as, for example, methyl, ethyl, n-propyl, i-propyl, butyl
R′=cycloalkyl
n=1-20
f) Organosilanes of the type (RO)₃Si(CH₂)ₘ—R′
R=alkyl, such as methyl, ethyl, propyl
m=0.1-20
R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH, —NR′R″R′″ wherein
R′=alkyl, aryl;
R″=H, alkyl, aryl;
R′″=H, alkyl, aryl, benzyl, C₂H₄NR″″ R′″″ with R″″=H, alkyl and
R′″″=H, alkyl
g) Organosilanes of the type(R″)ₓ(RO)_{y}Si(CH₂)ₘ—R′
R″=alkyl
x+y=2
=cycloalkyl x=1.2
y=1.2
m=0.1 to 20
R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH, —NR′R″R′″ wherein
R′=alkyl, aryl;
R″=H, alkyl, aryl;
R′″=H, alkyl, aryl, benzyl, C₂H₄NR″″ R′″″ with R″″=H, alkyl and
R′″″=H, alkyl
h) Halogen organosilanes of the type X₃Si(CH₂)ₘ—R′
X=Cl, Br
m=0.1-20
R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH
i) Halogen organosilanes of the type (R)X2Si(CH2)m-R′
X=Cl, Br
R=alkyl, such as methyl, ethyl, propyl
m=0.1-20
R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH,
j) Halogen organosilanes of the type (R)2X Si(CH2)m-R′
X=Cl, Br
R=alkyl
m=0.1-20
R′=methyl-, aryl (for example, —C₆H₅, substituted phenyl residues), C₄F₉, OCF₂—CHF—CF₃, —C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C=CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —Sₓ—(CH₂)₃Si(OR)₃, —SH

Preferably, as surface modifying agent, the following silanes are employed, either individually or in a mixture: dimethyldichlorosilane, octyltrimethoxysilane, oxtyltriethoxysilane, hexamethyldisilazane, 3 methacryloxypropyltrimethoxysilane, 3 methacryloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nanofluorohexyltrimethoxysilane, tridecafluorooctyltrimethoxysilane, tridecafluorooctyltriethoxysilane, aminopropyltriethoxysilane. Especially preferably, octyltrimethoxysilane and octyltriethoxysilane can be employed.

The resulting surface modified magnesium oxide shows high values for the BET surface between 50 to 350 m²/g, preferably 150 to 300 m²/g.

The pyrogenically prepared, surface modified magnesium oxide in accordance with the invention can be employed in broad variety of applications, for example in industrial applications such as electronics, catalysis, paints and oils, or for cathode and/or anode active material coating for production of cathodes and anodes used in lithium-ion as well as sodium-ion batteries.

Even without further explanations, it is assumed that a person skilled in the art can fully use the above description. The preferred embodiments and examples are therefore to be understood only as a descriptive, by no means as a limiting in any way.

In the following, the present invention is explained in more detail using examples. Alternative embodiments of the present invention are available in an analogous manner.

### FIGURES

FIG. 1 shows the TEM image of hydrophilic magnesium oxide. For the measurements a Hitachi H-7500 with an accelerating voltage 100 KV and a resolution of 0.34 nm was used.

FIG. 2 shows XRD spectra of a hydrophilic magnesium oxide obtained in Example 1. The samples were analyzed with a X-ray diffractometer from Malvern Pananlytical (X'Pert Pro).

### EXAMPLES

### Determination of the Physical-Chemical Characteristic Data

In the context of the present invention the following measurement methods for evaluating the characteristics for the different materials were used:

### A) BET Surface Area:

The BET surface area is determined in accordance with DIN 66 131 with nitrogen.

### B) Tamped Density:

Determination of the tamped density in adaptation of DIN ISO 787/XI,

### Fundamentals of the Tamped Density Determination:

The tamped density (formerly the tamped volume) is equal to the quotient of the mass and the volume of a powder after tamping in the tamping volumeter under predetermined conditions. In accordance with DIN ISO 787/XI, the tamped density is given in g/cm³. Because of the very low tamped density of the oxides, however, the value is given in g/L by us. Furthermore, the drying and sieving as well as the repetition of the tamping operation is dispensed with.

### Apparatus for Tamped Density Determination:

Tamping volumeter

Volumetric cylinder

Laboratory scale (Reading to 0.01 g)

### Carrying Out the Tamped Density Determination:

200±10 mL of oxide is filled into the volumetric cylinder of the tamping volumeter in such a way that no pores remain, and the surface is level. The mass of the filled sample is determined precisely to 0.01 g. The volumetric cylinder with the sample is placed in the volumetric cylinder holder of the tamping volumeter and tamped 1250 times. The volume of the tamped oxide is read off 1 time exactly.

### Evaluation of the Tamped Density Determination

$$Tamped density ( \frac{g}{L} ) = \frac{g weighed quantity}{mL volume read off} \times 1000$$

### C) pH Value:

The pH value is determined in 4% aqueous dispersion for hydrophobic oxides in Water:methanol (1:1).

### Reagents for the pH Value Determination:

Distilled or completely deionized water, pH>5.5

Methanol, p.a.

Buffer solutions pH 7.00 pH 4.66

### Apparatus for pH Value Determination:

Laboratory scale, (Reading to 0.1 g)

Glass beaker, 250 mL

Magnetic stirrer

Magnetic rod, length 4 cm

Combined pH electrodes

pH measuring apparatus

Dispensers, 100 mL

### Working Procedure for the Determination of the pH Value:

The determination is conducted in adaptation of DIN/ISO 787/IX:

Calibration: Prior to the pH value determination, the measuring apparatus is calibrated with the buffer solutions. If several measurements are carried out in succession, a single calibration suffices.

4 g of hydrophilic oxide is stirred into a paste in a 250 mL glass beaker with 96 g (96 mL) of water by use of a dispenser and stirred for five minutes with a magnetic stirrer while the pH electrode is immersed (rpm approx. 1000 min⁻¹).

4 g of hydrophobic oxide is stirred into a paste in a 250 mL glass beaker with 48 g (61 mL) of methanol and the suspension is diluted with 48 g (48 mL) of water and stirred for five minutes with a magnetic stirrer while the pH electrode is immersed (rpm approx. 1000 min-1).

After the stirrer has been switched off, the pH is read off after a standing time of one minute. The result is given to within one decimal place.

### D) Drying Loss

In contrast to the weighed quantity of 10 g mentioned in DIN ISO 787 II, a weighed quantity of 1 g is used for the drying loss determination.

The cover is put in place prior to cooling. A second drying is not conducted.

Approx. 1 g of the sample is weighed precisely to 0.1 mg into a weighing dish with a ground cover that has been dried at 105° C., the formation of dust being avoided, and dried for two hours in the drying cabinet at 105° C. After cooling in a desiccator with its cover still on, the sample is reweighed under blue gel.

$$\% Drying loss at 105 ° C . = \frac{g weight loss}{g weighed quantity} \times 100$$

The result is given to within one decimal place.

### E) Loss on Ignition

Apparatus for the determination of the loss on ignition:

Porcelain crucible with crucible cover

Muffle furnace

Analysis scale (Reading to 0.1 mg)

Desiccator

### Carrying Out the Loss on Ignition:

In departure from DIN 55 921, 0.3-1 g of the undried substance is weighed to precisely 0.1 mg into a porcelain crucible with a crucible cover, which have been heated red hot beforehand, and heated red hot for 2 hours at 1000° C. in a muffle furnace.

The formation of dust is to be carefully avoided. It has proven advantageous to place the weighed samples into the muffle furnace while the latter are still cold. Slow heating of the furnace prevents the creation of stronger air turbulence in the porcelain crucible. After 1000° C. has been reached, red-hot heating is continued for a further 2 hours. Subsequently, a crucible cover is put in place and the weight loss of the crucible is determined in a desiccator over blue gel.

### Evaluation of the Determination of the Loss on Ignition

Because the loss on ignition is determined relative to the sample dried for 2 h at 105° C., the following calculation formula results:

$$\% Loss of ignition = \frac{m 0 * \frac{100 - TV}{100} - {m}_{1}}{m 0 * \frac{100 - TV}{100}} * 100$$

m0=weighed quantity (g)
TV=drying loss (%)
m1=weight of the sample after being heated red hot(g)

The result is given to within one decimal place.

### F) Carbon Content

The carbon content is determined by elemental analysis using a LECO C744 instrument. The measurement principle is based on oxidizing the carbon in the sample to CO₂, which is then quantified by infrared detectors.

### Preparation of Magnesium Oxide:

### Example 1: Preparation of the Pyrogenically Prepared Magnesium Oxide

1,89 Kilogram of an aqueous solution containing 1000 g of Mg(CH₃COO)₂*4H₂O was prepared.

An aerosol of 2.5 kg/h of this dispersion and 15 Nm³/h of air was formed via a two-component nozzle and sprayed into a tubular reaction with a burning flame. The burning gases of the flame consisted of 8 Nm³/h of hydrogen and 30 Nm³/h of air. Additionally, 25 Nm³/h of secondary air was used. After the reactor the reaction gases were cooled down and filtered.

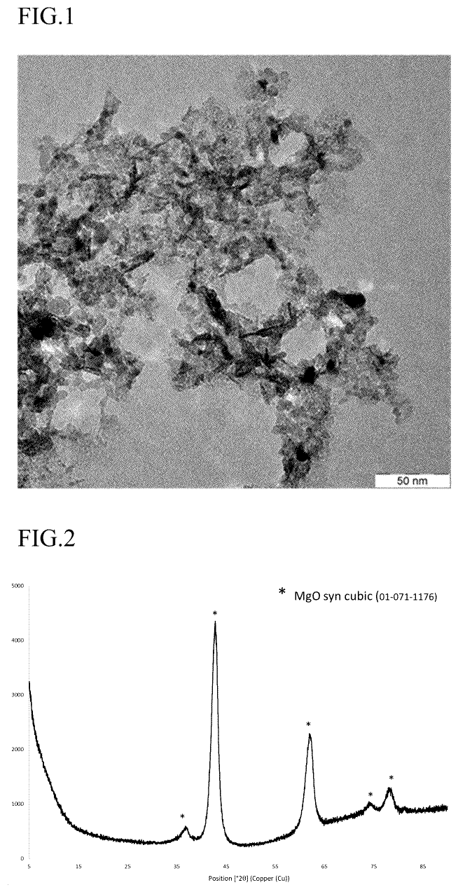

The particle properties are shown in Table 1, the TEM image of the particles is shown in FIG. 1 and the XRD analysis (FIG. 2) showed, that the major phase of the product was cubic magnesium oxide.

The high surface area, pyrogenically prepared hydrophilic magnesium oxide that forms has the physical-chemical characteristic data shown in Table I.

### Example 2: Preparation of Surface-Modified Magnesium Oxide

300 g of pyrogenically prepared magnesium oxide (example 1) are placed in a mixer and sprayed with 72 g octyltrimethoxysilane. After the spraying of the silane on the powder is finished, mixing is continued for additional 5 min. Then tempering of the wetted powder is carried out for 3 h at 130° C. in an oven.

The surface modified magnesium oxide that forms has the physical-chemical characteristic data shown in Table I.

### Example 3: Preparation of Surface-Modified Magnesium Oxide

300 g of pyrogenically prepared magnesium oxide (example 1) are placed in a mixer and sprayed with 36 g octyltrimethoxysilane. After the spraying of the silane on the powder is finished, mixing is continued for additional 5 min. Then tempering of the wetted powder is carried out for 3 h at 130° C. in an oven.

The hydrophilic and surface modified magnesium oxides have the physical-chemical characteristic data shown in Table I.

TABLE 1
Properties

| Properties | Example 1 | Example 2 | Example 3 |
|---|---|---|---|
| BET [m²/g] | 240 | 225 | 234 |
| Tamped Density [g/L] | 56 | 78 | 63 |
| pH value | 10.5 | 10.2 | 10.3 |
| Drying loss [%] | 0.5 | 0.6 | 0.2 |
| Loss on ignition [%] | 12.2 | 17.6 | 14.0 |
| Carbon content [%] | 0.0 | 9.7 | 5.9 |

1. A pyrogenically prepared, surface modified magnesium oxide, having a surface area according to standard DIN 66 131 of 50 to 350 m²/g, a tamped density according to standard DIN ISO 787/XI of 20 to 120 g/L, a drying loss according to standard DIN ISO 787 II of less than 5%, a loss on ignition according to standard DIN 55 921 of 0.1 to 20%, and a carbon content according to elemental analysis using a LECO C744 instrument of 0.1 to 15%.

2. A process for the preparation of the pyrogenically prepared, surface modified magnesium oxide according to claim 1, the process comprising:
spraying a surface modifying agent on a pyrogenically prepared hydrophilic magnesium oxide at room temperature, and
subsequently thermally treating at a temperature of 50 to 300° C. over a period of 0.5 to 3 h.

3. A The process for the preparation of the pyrogenically prepared, surface modified magnesium oxide according to claim 1, the process comprising:
spraying a surface modifying agent in vapor form on a pyrogenically prepared hydrophilic magnesium oxide, and
subsequently thermally treating at a temperature of 50 to 800° C. over a period of 0.5 to 6 h.

4. The process according to claim 2, wherein the preparation of the pyrogenically prepared hydrophilic magnesium oxide is a flame spray pyrolysis process of at least one solution of metal precursors, the solution comprising:
a magnesium salt, and
a solvent.

5. The process according to claim 4, the flame spray pyrolysis process comprising:
a) atomizing the solution of metal precursors to afford an aerosol by an atomizer gas,
b) reacting the aerosol in a reaction space of a reactor with a flame obtained by ignition of a mixture of fuel gas and an oxygen-containing gas to obtain a reaction stream,
c) cooling the reaction stream, and
d) subsequently removing the solid magnesium oxide from the reaction stream.

6. The process according to claim 2, wherein the pyrogenically prepared hydrophilic magnesium oxide has a surface area according to standard DIN 66 131 of 50 to 350 m²/g, a tamped density according to standard DIN ISO 787/XI of 20 to 100 g/L, a drying loss according to standard DIN ISO 787 II of less than 5%, and a loss on ignition according to standard DIN 55 921 of 0.1 to 15%.

7. A The process according to claim 2, wherein the surface modifying agent, either individually or in a mixture, is selected from the group consisting of dimethyldichlorosilane, octyltrimethoxysilane, oxtyltriethoxysilane, hexamethyldisilazane, 3 methacryloxypropyltrimethoxysilane, 3 methacryloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nanofluorohexyltrimethoxysilane, tridecafluorooctyltrimethoxysilane, tridecafluorooctyltriethoxysilane, and aminopropyltriethoxysilane.

8. Electronics, catalysis material, paints and oils, and cathode and/or anode active material coating for production of cathodes and anodes used in lithium-ion as well as sodium-ion batteries comprising the pyrogenically prepared, surface modified magnesium oxide according to claim 1.
